(19) United States
(12) Patent Application Publication
(10) Pub. No.: US 2007/0138685 A1
(43) Pub. Date: Jun. 21, 2007

(54) Method for manufacturing counter tops

(75) Inventors: Kenneth G. Trinder, Norfolk, VA (US); Evan Kruger, Suffolk, VA (US)

Correspondence Address: WILLIAMS MULLEN, FOUNTAIN PLAZA THREE, SUITE 200, 721 LAKEFRONT COMMONS, NEWPORT NEWS, VA, 23606, US

(73) Assignee: EOS Surfaces, L.L.C.

(21) Appl. No.: 11/705,240

(22) Filed: Feb. 12, 2007

Related U.S. Application Data
(63) Continuation of application No. 11/304,418, filed on Dec. 15, 2005.
(60) Provisional application No. 60/636,370, filed on Dec. 15, 2004.

(51) Int. Cl. B28B 1/08; B32B 27/32

(52) U.S. Cl. 264/71; 264/122; 428/220

(57) ABSTRACT

An improved solid surface which, by means of an increased thickness, reduces fabrication time and cost. The solid surface is manufacture from alumina tri-hydrate, ground up granules of a previously cast solid surface and resin. A catalyst is added and the resulting mixture is poured onto a mold and cured to form a sheet of solid surface having a thickness of about 3 cm. The solid surface may be used for counter tops.

### CROSS REFERENCE TO RELATED APPLICATIONS

The present application claims priority from U.S. Provisional Application Ser. No. 60/636,370, filed Dec. 15, 2004.

### FIELD OF THE INVENTION

The invention is generally related to manufacture of a counter top. More particularly, the invention is directed to an improved method for manufacturing a single layer counter top of acceptable thickness.

### DESCRIPTION OF RELATED ART

Various processes and procedures are known in the art for producing solid surface and cultured marble countertops. The term solid-surface pertains to a material where there is no painted or laminated skin or outer surface. With solid surface materials, small scratches and burns, etc. are sanded or buffed out.

The industry for solid surfacing began approximately twenty-five years ago when Dupont Inc. developed a high quality surfacing material known commercially as Corian®. Since the early 1980s, several major manufacturers have developed their own brand of solid surface products. The overwhelming majority of these products are ½″ in thickness. For the most part, these products are expensive to produce and are distributed in nominal sized sheets that are fabricated by cutting the sheet into the desired counter top shape and rebounding by adhesive, or the like, to a substrate surface.

The cutting and rebounding of the sheets and adhesions to a substrate were always necessary due to the thin nature of the material. Accordingly, the finish fabrication of solid-surface sheets has always been labor intensive.

Counter tops are used in a variety of places, such as the kitchen or bathroom, to provide a horizontal work space. Methods for manufacturing prior counter top materials resulted in thin sheets of material having thicknesses of ½″ to ¾″. To provide a finished counter top of sufficient thickness, traditionally, these ½″ thick sheets of solid surface material were cut into sheets to generate pieces to glue up to the ends of the sheet material. These pieces were glued together to create a thicker edge on the material and then sanded down to create a finished product. Gluing the sheets adds numerous manufacturing steps which results in an expensive end product.

Accordingly, it is an object of the present invention to provide an improved counter top material.

It is another object of the present invention to provide an improved counter top material of an appropriate thickness.

It is another object of the present invention to provide an improved counter top which is not manufactured by gluing or attaching several layers to achieve an appropriate thickness.

It is another object of the present invention to provide an improved counter top which is does not require installation over a substrate.

It is another object of the present invention to provide a method for manufacturing a counter top which results in a single layer counter top.

It is a further object of the present invention to provide a method for manufacturing a counter top which reduces the finishing labor required.

It is yet a further object of the present invention to provide a method for manufacturing a counter top which is simple.

Finally, it is an object of the present invention to accomplish the foregoing objectives in a safe and cost effective manner.

### SUMMARY OF THE INVENTION

A method for manufacturing a solid surface is provided. In this method, alumina tri-hydrate is poured into a vat mixer having vacuum capabilities. A previously cast solid surface, preferably made from alumina tri-hydrate, granules and resin, is ground into granules and added to the vat. A resin, preferably acrylic resin, polyester resin or polyester acrylic resin, is added to form a mixture wherein the alumina tri-hydrate and granules comprise at least thirty-five percent of the mixture. In the preferred embodiment, the alumina tri-hydrate and granules comprise between fifty and seventy percent of the mixture. In the most preferred embodiment, the alumina tri-hydrate and granules comprise fifty-five percent of the mixture and the resin comprises forty-three percent of the mixture. In the most preferred embodiment, the resin is polyester acrylic resin comprised of idophthalic acid, acrylic ester, propanediol, diethylene glycol, malice anhydride, ethylene glycol, benze anhydride and adipic anhydride. The ingredients are mixed until a homogeneous mixture is formed and a catalyst, preferably peroxide, is blended into the homogeneous mixture to form a moldable mixture. If desired, polyester coloring pastes, or other appropriate ingredients, can be added to impart color to the homogeneous mixture. The moldable mixture is then poured onto a glass, stainless steel or fiberglass mold, cured to form a sheet of solid surface and then released from the mold. To settle the moldable mixture onto the mold, before curing, the moldable mixture may be agitate by, for example by vibration. The curing process preferably occurs at an elevated temperature initially, preferably at about 130° F. for about 2 hours and then at 65° F. to 85° F. for about 4 hours. Once the sheet is removed from the mold, the sheet can then be polished using, preferably, varying grits of diamond polishing pads and water to provide finished sheets of solid surface.

### DETAILED DESCRIPTION OF THE PREFERRED EMBODIMENT

While the preferred embodiment is specifically described for use with certain materials mixed at certain ratios and cured at certain rates and temperatures, it will be well understood by those of ordinary skill that alternate materials mixed at alternate ratios and cured at alternate rates and temperatures are contemplated.

The invention is an improved composition for solid surface countertop material. Previous compositions resulted in sheets of material having thicknesses of ½″ to ¾″. This novel method produced a solid surface having a thickness of 3 cm which allows for simplified end user fabrication and tremendous labor savings from the cast thickness of the material. Traditionally, users of ½″ solid surface material had to cut sheets of the material to generate pieces to glue up to the ends of the sheet materials. These pieces were glued together to create a thicker edge on the material and then sanded down to create a finished product. The present invention eliminates this step as no edge build up is necessary due to the increased thickness of the material. The present invention relates to countertops primarily used for kitchens and bathrooms and allows for a significant labor savings in end fabrication of the countertops due to increased material thickness.

The process for manufacturing a solid surface according to the present method includes the following steps:

Alumina tri-hydrate (hereinafter “ATH”) is poured into a vat mixer with vacuum capabilities along with ground up granules of a previously cast solid surface which are comprised of the same ingredients and made according to the same process described herein.

Acrylic resin, polyester resin or, preferably, polyester acrylic resin (hereinafter “Resin”) is added to the vat mixer such that the finished mixture will provide the desired characteristics of the finished solid surface. The mixture preferably includes at least thirty-five percent (35%) ATH and crushed granules. The most preferred embodiment includes fifty-five percent (55%) ATH and crushed granules mixed with forty-three percent (43%). The resulting mixture is then mixed in the vat under a vacuum until the mixture is homogenous.

Once the mixture is homogeneous, if desired, polyester coloring pastes are added to effect the desired color. A catalyst is then added to promote the hardening process; peroxide is the preferred catalyst. The optional pastes and catalyst are fully blended into the mixture.

The resulting mixture is then poured onto molds of varying sizes depending upon the desired dimensions of the finished sheets of solid surface. Glass molds are preferred for ease of use but stainless steel or fiberglass molds can also be used with the appropriate mold releases. The cast mixture is then preferably agitated to settle in the mold, preferably by vibration.

The cast mixture is then cured to form a sheet. Preferably, the mold is then moved into an oven to cure at an elevated temperature, preferably around 130° F. Lower temperatures may also be used; an excessive temperature can cause the sheet to warp. Following oven curing, preferably, the curing process continues outside the oven on racks at approximately room temperatures for several hours. The cast sheets are then released from the molds and polished using varying grits of diamond polishing pads and water to provide finished sheets of solid surface.

### EXAMPLE

a) alumina tri-hydrate (hereinafter “ATH”) is poured into a vat mixer with vacuum capabilities along with ground up granules of a previously cast solid-surface which are comprised of the same ingredients and made according to the same process described herein;

b) polyester acrylic resin, comprised of idophthalic acid, acrylic ester, propanediol, diethylene glycol, malice anhydride, ethylene glycol, benze anhydride and adipic anhydride (hereinafter “Resin”) is added to the vat mixer such that the ratio of the mixture is fifty-five percent (55%) ATH and crushed granules to forty three percent (43%) Resin;

c) the resulting mixture is mixed in the vat under a vacuum for eight to ten minutes until the mixture is homogenous;

d) once the mixture is homogeneous, polyester coloring pastes are added to effect the desired color and peroxide is added to act as a catalyst for the hardening process;

e) the pastes and peroxide are fully mixed in;

f) the resulting mixture is poured onto glass molds of varying sizes depending upon the desired dimensions of the finished sheets of solid surface;

g) the cast mixture is vibrated until an even mixture and settlement is realized;

h) the cast sheet is then moved into an oven to cure for two hours at 130° F.;

i) following the oven curing, the cast sheet cures outside the oven on racks for another four hours at a temperature between 65° F. and 85° F.; and

j) the cast sheets are then released from the mold and polished using varying grits of diamond polishing pads and water to provide finished sheets of solid surface having a thickness of 3 cm.

While the description above refers to particular embodiments of the present invention, it will be understood that many modifications may be made without departing from the spirit thereof. The accompanying claims are intended to cover such modifications as would fall within the true scope and spirit of the present invention.

1. A method for manufacturing a solid surface, comprising:
pouring alumina tri-hydrate into a vat mixer having vacuum capabilities;
pouring ground up granules of a previously cast solid surface;
adding a resin to the vat mixer to form a mixture wherein the alumina tri-hydrate and granules comprise at least thirty-five percent of the mixture;
mixing the alumina tri-hydrate, granules and resin until a substantially homogeneous mixture is formed;
following mixing, adding a catalyst to the vat;
mixing in the catalyst to form a substantially homogeneous moldable mixture;
pouring the substantially homogeneous moldable mixture onto a mold;
curing the substantially homogeneous moldable mixture to form a substantially homogeneous sheet of solid surface; and
releasing the homogeneous sheet from the mold.

2. The method of claim 1 wherein the ground granules are obtained by:
providing a cured sheet of solid surface manufactured from alumina tri-hydrate, granules and resin; and
grinding the cured sheet to form granules.

3. The method of claim 1 wherein the alumina tri-hydrate and granules comprise between fifty and seventy percent of the mixture.

4. The method of claim 1 wherein the alumina tri-hydrate and granules comprise fifty-five percent of the mixture and the resin comprises forty-three percent of the mixture.

5. The method of claim 1 wherein the resin is selected from the group consisting of acrylic resin, polyester resin and polyester acrylic resin.

6. The method of claim 1 wherein the resin is polyester acrylic resin comprised of isophthalic acid, acrylic ester, propanediol, diethylene glycol, maleic anhydride, ethylene glycol, benzene anhydride and adipic anhydride.

7. The method of claim 1, further comprising the step:
imparting a desired color to the homogenous mixture.

8. The method of claim 7 wherein at least one polyester coloring paste imparts the desired color to the homogeneous mixture.

9. The method of claim 1 wherein the catalyst is peroxide.

10. The method of claim 1 wherein the mold is selected from the group consisting of glass, stainless steel and fiberglass.

11. The method of claim 1 wherein the mold is glass.

12. The method of claim 1 further comprising:
following the pouring step, the moldable mixture is agitated such that the moldable mixture settles on the mold.

13. The method of claim 12 wherein agitation of the moldable mixture is caused by vibrating the mold.

14. The method of claim 1 wherein curing step comprises:
applying a predetermined amount of heat to the moldable mixture for a first predetermined amount of time; and
removing the heat from the moldable mixture for a second predetermined amount of time.

15. The method of claim 1 wherein curing step comprises:
placing the mold into an oven and heating the moldable mixture to about 130° F. for about two hours; and
removing the mold from the oven to a temperature of about 65° F. to 85° F. for four hours.

16. The method of claim 1 further comprising:
following the releasing step, polishing the sheet to provide finished sheets of solid surface.

17. The method of claim 16 wherein the sheet is polish with diamond polishing pads and water.

18. A substantially homogeneous sheet of solid surface consisting essentially of alumina tri-hydrate, ground up granules of a previously cast solid surface and resin mixed into a homogeneous mixture and further mixed with a catalyst wherein the homogenous mixture and resin are poured onto a mold and cured to form the substantially homogeneous sheet having a thickness of about 3 cm.

19. The sheet of claim 18 wherein the resin is selected from the group consisting of acrylic resin, polyester resin and polyester acrylic resin and the catalyst is peroxide.

20. The sheet of claim 18 wherein the alumina tri-hydrate and ground up granules of a previously cast solid surface comprise at least thirty-five percent of the homogeneous mixture.
